(19) United States
(12) Patent Application Publication
(10) Pub. No.: US 2013/0204982 A1
(43) Pub. Date: Aug. 8, 2013

(54) SERVER AND SERVICE PROVIDING METHOD THEREOF

(71) Applicants: Seon-hak Kim, Seoul (KR); Nam-geol Lee, Seoul (KR); Il-Ho Lee, Gyeonggi-do (KR)

(72) Inventors: Seon-hak Kim, Seoul (KR); Nam-geol Lee, Seoul (KR); Il-Ho Lee, Gyeonggi-do (KR)

(73) Assignee: SAMSUNG ELECTRONICS CO., LTD., Suwon-si, Gyeonggi-do (KR)

(21) Appl. No.: 13/876,977

(22) PCT Filed: Sep. 28, 2011
(86) PCT No.: PCT/KR2011/007144

§ 371 Date: Mar. 29, 2013

(30) Foreign Application Priority Data
Sep. 30, 2010 (KR) 10-2010-0095544

(51) Int. Cl. H04L 29/06

(52) U.S. Cl. CPC H04L 29/06312
USPC 709/219

(57) ABSTRACT

Methods and apparatus are provided for providing a hub service is provided. Access is provided to a user terminal device. It is determined whether the user terminal device is a pre-registered device. A service hub program set for the user terminal is transmitted from the server to the user terminal device, when the user terminal device is the pre-registered device. At least one application program corresponding to the service hub program and the user terminal device is transmitted from the server to the user terminal device.

### PRIORITY

This application is a National Phase Entry of PCT Application No. PCT/KR2011/007144, filed on Sep. 28, 2011, and claims priority to Korean Patent Application No. 10-2010-0095544, filed in the Korean Intellectual Property Office on Sep. 30, 2010, the contents of each of which are incorporated herein by reference.

### BACKGROUND OF THE INVENTION

1. Field of the Invention

The present invention relates generally to a server and a service providing method thereof, and more particularly, to a server for collectively providing a plurality of services by offering a service hub to a user terminal device belonging to a particular organization, and a service providing method thereof.

2. Description of Related Art

Due to advances of electronic technology, various electronic devices including, most advanced user terminal devices based on the outstanding Information Technology (IT), such as smart phones, are supplied.

Therefore, efforts to develop various and convenient applications for the most advanced user terminal devices are accelerating.

A user terminal device can access an external server such as application store, in order to utilize various application programs in addition to application programs installed to the device. Accordingly, the user terminal device can download and use a free or paid application program.

Meanwhile, as the number of users of the portable user terminal devices increases, various-scale organizations, such as enterprise, school, hospital, and public institutions, can use a specific application program in common. Therefore, users belonging to the organization must individually download and utilize such an application program.

However, it may be difficult for a user that is unfamiliar with the user terminal device to download and install the application program. In addition, when there are multiple application programs that are commonly required by users of the same organization, it can be burdensome to search each user and download each of the common application programs one at a time.

### SUMMARY OF THE INVENTION

The present invention has been made to address at least the above problems and/or disadvantages and to provide at least the advantages described below. Accordingly, an aspect of the present invention provides a server for allowing use of a plurality of services all together by providing a service hub to a user terminal device belonging to a particular organization, and a service method thereof.

According to an aspect of the present invention, a service method of a server for providing a hub service is provided. Access is provided to a user terminal device. It is determined whether the user terminal device is a pre-registered device. A service hub program set for the user terminal is transmitted from the server to the user terminal device, when the user terminal device is the pre-registered device. At least one application program corresponding to the service hub program and the user terminal device is transmitted from the server to the user terminal device.

According to another aspect of the present invention, a server is provided for providing a hub service. The server includes a contents server unit for storing service hub programs and application programs. The server also includes a front server unit for, when a user terminal device is provided access, determining whether the user terminal device is a pre-registered device. The server further includes a main server unit for, when the user terminal device is the pre-registered device, controlling the front server unit to transmit a service hub program corresponding to the user terminal device and at least one application program corresponding to the service hub program and the user terminal device, among the service hub programs and the application programs stored to the contents server unit, to the user terminal device.

### BRIEF DESCRIPTION OF THE DRAWINGS

The above and other aspects, features, and advantages of the present invention will become apparent from the following detailed description when taken in conjunction with the accompanying drawings in which:

FIG. 1 is a diagram illustrating a network system, according to an embodiment of the present invention;

FIG. 2 is a diagram illustrating a screen configuration of a user terminal device, according to an embodiment of the present invention;

FIGS. 3 through 8 are block diagrams illustrating the user terminal device, according to embodiments of the present invention;

FIGS. 9 and 10 are diagrams illustrating a method for downloading and installing a service hub program in the user terminal device, according to an embodiment of the present invention;

FIGS. 11 and 12 are block diagrams illustrating a server, according to embodiments of the present invention;

FIG. 13 is a diagram illustrating a service hub registration process, according to an embodiment of the present invention;

FIG. 14 is a diagram illustrating an application program setting process, according to an embodiment of the present invention;

FIGS. 15 through 18 are diagrams illustrating service hub management of an operator of an organization assigned a server account, according to an embodiment of the present invention;

FIG. 19 is a diagram illustrating a method for setting an application program per group, according to an embodiment of the present invention;

FIG. 20 is a flowchart illustrating a service providing method of the user terminal device, according to an embodiment of the present invention;

FIG. 21 is a flowchart illustrating a method for installing the service hub program, according to an embodiment of the present invention;

FIG. 22 is a flowchart illustrating a method for processing the application program corresponding to the service hub program, according to an embodiment of the present invention;

FIG. 23 is a flowchart illustrating a method for limiting program availability according to a location in the user terminal device, according to an embodiment of the present invention;

FIG. 24 is a flowchart illustrating a method for deleting a program or data according to state change in the user terminal device, according to an embodiment of the present invention;

FIG. 25 is a sequence diagram between the user terminal device and the server, according to an embodiment of the present invention; and

FIGS. 26 and 27 are flowcharts illustrating the service providing method of the server, according to embodiments of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

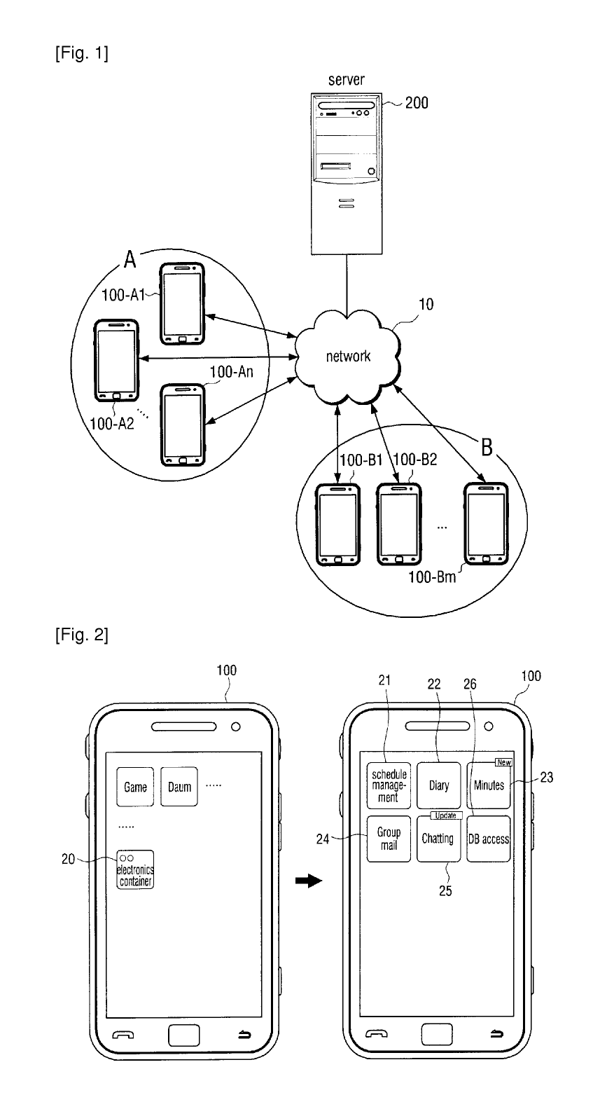

FIG. 1 is a schematic diagram illustrating a system for providing a service, according to an embodiment of the present invention.

Referring to FIG. 1, a network system according to an embodiment of the present invention includes a plurality of user terminal devices 100-A1 through 100-An and 100-B1 through 100-Bm, a network 10, and a server 200.

The network 10 can be implemented using a general communication network or a wired/wireless Internet network.

The user terminal devices can be classified based on an organization of the user. More specifically, the user terminal devices are classified to the user terminal devices 100-A1 through 100-An belonging to an organization A, and the user terminal devices 100-B1 through 100-Bm belonging to an organization B.

The server 200 offers an adaptive application program for the user or the user's terminal device belonging to the corresponding organization on a contract with the organization.

More specifically, a provider for operating the server 200 generates a certain contract and receives a service request from a representative of the organization. Accordingly, the provider registers a service hub for the corresponding organization and configures an adaptive service hub program for the organization. The service hub program indicates a program provided and installed in the user terminal device belonging to the organization, in order to easily download, update, and manage at least one application program set in the user terminal device for the corresponding organization.

When the organization A requests the service in FIG. 1, the server 200 receives various information, such as users belonging to the organization A and user terminal devices of the user, and registers the service hub based on the received information. The service hub program may be generated by altering only detailed setup items such as webpage skins, menus, and available application program setups, while sustaining a basic platform in its current form, or by newly designing the service hub program according to the request of the corresponding organization.

At this time, when the user terminal devices 100-A1 through 100-An of the organization A respectively access the server 200, the server 200 transmits the service hub program corresponding to the organization A to the accessed user terminal device.

Meanwhile, authentication can be performed before the service hub program is transmitted. The authentication can be performed according to various well-known techniques. For example, the user terminal device can transmit, to the server 200, user information (e.g., IDentification (ID) and password) and unique information of the user terminal device (e.g., International Mobile Equipment Identity (IMEI), Mobile Station International Subscriber Directory Number (MSISDN), etc.) In this case, the user information such as ID or password can be provided from the server 200 for the corresponding organization. More specifically, the operator of the organization can notify the provided information to each user to use the information to install the service hub program. When receiving the user information and the unique information of the user terminal device, the server 200 can perform the authentication by comparing the received information with the information provided from the corresponding organization in advance. When completing the authentication, the server 200 can transmit the service hub program corresponding to the relevant user terminal device.

When the user terminal device downloads and installs the service hub program, an icon container is generated and displayed in a screen of the user terminal device. The icon container corresponds to the service hub, i.e., the service hub program. The service hub program itself may also be referred to as a hub container.

When the user selects the corresponding icon container, the screen of the user terminal device displays icons of the application programs for the organization or the group (e.g., department, rank, gender, age, etc.) of the corresponding user in the organization.

In this case, the corresponding application programs may be downloaded from the server 200 all together or selectively.

Meanwhile, when a manufacture of the user terminal device is the same as a provider of the server 200 (or even when they are different), a user terminal device pre-containing the service hub program used by the corresponding organization and the application programs to be used by the service hub program may be sold to the corresponding organization.

In other words, the service hub program and the application programs may already be installed when the user terminal device is released.

Accordingly, the users of the organization A can collectively use various application programs by executing the service hub program provided from the server 200. More specifically, the user can download the application programs collectively or selectively. When an old version of the program already exists, the old version of the program may be easily updated.

In the meantime, when the organization B does not make a separate contract with the server 200, the user terminal devices 100-B 1 through 100-Bm of the organization B cannot receive the service hub program.

The server 200 may limit the service use according to a changed location or state of the user terminal device.

For example, when the location of the user terminal device leaves an effective area, the availability of the service hub program installed to the user terminal device or at least one of the application programs provided for the service hub program and the user terminal device can be restricted.

A method for restricting the availability can be implemented variously in different embodiments of the present invention. Without intervention of the server 200, the user terminal device itself can determine whether to use a restriction by obtaining and comparing its location information with effective area information. For the program determined as unavailable, the user terminal device can delete the corresponding displayed icon, or display the icon in the deactivated state. Alternatively, while displaying the icon normally, the user terminal device can display an error message without performing an operation of the program when the icon is selected. The effective area information can be provided from the server 200, a plurality of effective areas can be defined, or the effective area information can be changed.

Alternatively, the server 200 can directly restrict the availability by comparing a location of the user terminal device and the effective area. For example, the server 200 can receive location information periodically, or whenever a particular event (e.g., when the user terminal device transits from a turn-off state to a turn-on state) from the user terminal device occurs. In this case, unique information of the user terminal device can be received together with the location information. Upon locating the user terminal device, the server 200 determines whether the location falls within the effective area. When the user terminal device is within the effective area, the server 200 does not restrict the availability of a corresponding service hub program or application program. However, when the user terminal device is located outside of the effective area, the server 200 restricts the availability of the service hub program or at least one application program. More specifically, the server 200 can generate and send, to the user terminal device, a list of unavailable programs, send availability information setting the availability, or send a command instructing the user terminal device to set the unavailable state.

Accordingly, the user terminal device disables a particular application program or the service hub program.

In the meantime, as explained above, the server 200 can restrict the use of services according to the state change of the user terminal device. More specifically, when the state of the user terminal device or the user is changed, for example, when the user of the user terminal device withdraws from his/her organization (e.g., in case of resignation or dispatch), when the user loses the user terminal device, when the user transfers to another department, or when the user takes time off, the server 200 can delete the application programs or the service hub program adaptively set for the corresponding organization, or disable the application programs or the service hub program for a long term.

The information indicating the changed of the user terminal device can be received at the server 200 from the corresponding organization or the user. The server 200 can send a deletion instruction or a suspension instruction according to the received information or request. Accordingly, the corresponding user terminal device can delete or suspend the designated program. In this case, the program as well as data generated during execution of the corresponding program can be deleted or suspended.

The server 200, which has all of information relating to the user terminal devices of the organization, can support a group service based on the above-described information.

More specifically, the server 200 can support a group mail service so that a group mail (or message) can be transferred between the user terminal devices. When the user terminal device requests a group mail transmission, the server 200 sends the group mail for the service hub or a particular group of the service hub using pre-stored information.

In further detail, the user of the user terminal device 100 can request to send a message for a particular user or group using his/her device. The server 200 searches for a transmission target using pre-registered information and then sends a message to the searched target.

The server 200 can send a notification message to the entire corresponding service hub or a group in the service hub. For example, the server 200 can directly input a notification message and send the notification message to each user terminal device.

The server 200 can provide an organization address book of the organization to thus support a service allowing the user to inquire about other user information in the organization/group.

When the user of the user terminal device selects an address book check service using his/her device, the user terminal device 100 requests a user list or detailed information of the service hub to the server 200. According to the request, the server 200 can send the address book recording phone numbers or e-mail information.

FIG. 2 is a diagram illustrating operations of a user terminal device, according to an embodiment of the present invention. Referring to FIG. 2, the screen of the user terminal device 100 with the service hub program installed displays an icon container 20.

The icon container 20, which is generated in accordance with the service hub program, includes an icon such as a container including icons of the application programs for the corresponding user terminal device 100 and the corresponding service hub program.

When the user selects the icon container 20, icons 21 through 26 included in the corresponding icon container 20 are displayed in the screen. While FIG. 2 depicts six icons displayed, the number of the icons is not limited to six in accordance with embodiments of the present invention. When the application programs corresponding to the icon container 20 are not set, the screen may not display any icons in response to selection of the icon container 20.

In FIG. 2, a word such as New or Update is displayed in one side of the icons 23 and 25 of the icons 21 through 26. As shown by these examples, when an icon is displayed, its display state can differ according to the state of the application program corresponding to the icon. For example, the word ‘New’ can be displayed in a side of the icon corresponding to the application program that has not yet been installed, and the word Update can be displayed in a side of the icon corresponding to an old version of application program. In addition to those words, when the application program of the latest version is normally installed, expression such as ‘Normal’ or ‘No change’ may be displayed in one side of the corresponding icon. The user terminal device 100 can also inform a user of an abnormal state of an application corresponding to an icon by flickering the icon or by changing a color, a location, a size, or a shape of the icon.

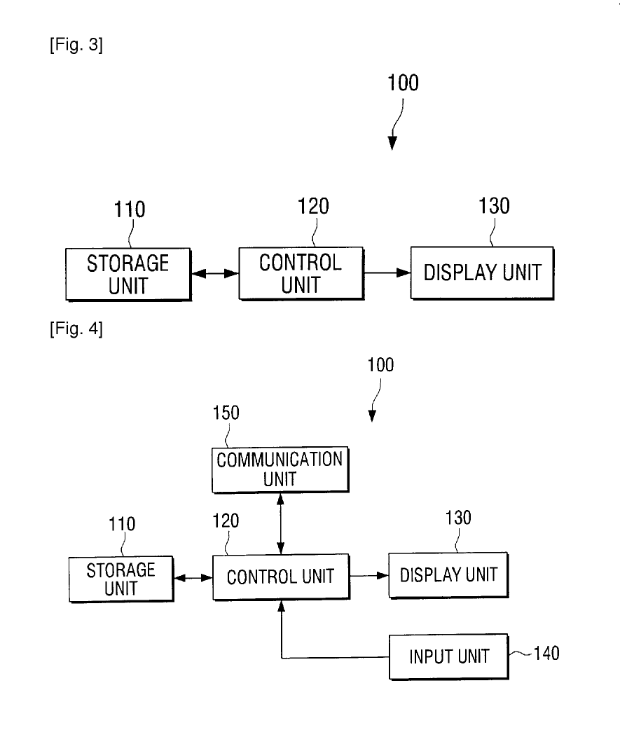

FIG. 3 is a block diagram illustrating a user terminal device, according to an embodiment of the present invention.

The user terminal device of FIG. 3 can be one of the user terminal devices 100-A1 through 100-An and 100-B1 through 100-Bm in the system of FIG. 1, and may be implemented using various terminal devices such as mobile phones, such as a smart phone, a Personal Digital Assistant (PDA), an electronic notebook, a Moving Picture Experts Group (MPEG) Audio Layer-3 (MP3) player, a notebook, and a Personal Computer (PC). The user terminal device is not necessarily limited to portable terminal devices, and may be implemented by using various terminal devices such as a TeleVision (TV), PC, and digital photo frame.

Referring to FIG. 3, the user terminal device 100 includes a storage unit 110, a control unit 120, and a display unit 130.

The storage unit 110 can store the service hub program and the application programs available in the user terminal device 100.

The display unit 130 displays the icon container generated according to the installation of the service hub program.

When the displayed icon container is selected, the control unit 120 displays the icons of the application programs set to be provided to the user terminal device 100 and the service hub program in the screen.

More specifically, the control unit 120 can collectively or selectively download at least one application program from the server 200 by executing the service hub program stored to the storage unit 110.

The service hub program can be pre-installed to the storage unit 110, or downloaded and installed later by downloading from the server 200.

FIG. 4 is a block diagram illustrating a user terminal device for downloading the service hub program from the server 200, according to an embodiment of the present invention.

Referring to FIG. 4, the user terminal device 100 includes the storage unit 110, the control unit 120, the display unit 130, an input unit 140, and a communication unit 150.

The communication unit 150 downloads the service hub program and the application programs from the server by accessing the server.

The input unit 140 can input user information or commands. The input unit 140 can be implemented using a touch screen integrally formed with the display unit 130, or by using a key separated from the display unit 130.

When the user information is input through the input unit 140, the control unit 120 can perform the authentication by sending the user information and the unique information of the user terminal device to the server via the communication unit 150.

When the authentication is accomplished, the control unit 120 can download the service hub program from the server 200 and install the service hub program to the storage unit 110. Hence, the control unit 120 can generate and display an icon container corresponding to the service hub program in a screen through the display unit 130.

The control unit 120 may receive information of the application programs from the server 200 by executing the service hub program. More specifically, the control unit 120 may download the application programs, a list of the application programs, or a list of the icons.

For example, when the service hub program is installed and executed, the control unit 120 can transmit, to the server 200, at least one of various information such as user information, unique information, and identification information of the service hub program via the communication unit 150.

Hence, the control unit 120 can receive a first list of the application programs corresponding to the service hub program and a second list of the icons of the application programs from the server 200.

Next, according to the second list, the control unit 120 can generate an icon container including icons for the application programs of the first list, and the icons, and provide them to the display unit 130.

Herein, the first list can be a list including at least one application program designated for the organization and the group of the user of the user terminal device.

The first list and the second list can be utilized in various ways.

For example, when the service hub program is initially executed, the control unit 120 can receive the first list, collectively download the application programs of the first list from the server 200, and install the downloaded application programs to the storage 110. Alternatively, even when a plurality of application programs to be updated or to be newly installed are registered for the service hub, the application programs or the update data can all be downloaded together. In this case, the execution screen of the service hub program displays a menu requesting the collective download or the collective update. When the user selects the corresponding menu, the corresponding operation is performed.

For example, the control unit 120 can check the state of the existing application program currently downloaded or installed to the user terminal device 100 and thus determine whether the application programs of the first list include an application to update or install. Upon determining the application program to update or install, the control unit 120 can control the display unit 130 to change the display state of the icon according to the state of the corresponding application program.

For example, when the application program is not yet installed and needs to be installed, the control unit 120 can display the icon of the application program together with a word, such as ‘New or Download’, informing the user of the new download in one side of the icon.

Alternatively, the control unit 120 can inform the user of new download for the corresponding application program by changing the color, the location, or the shape of the application program icon, or by flickering the icon. Even when the old version of the application program has already been installed, the control unit 120 can inform the user of the state by displaying a word such as ‘Update’ or by changing the display attribute.

Accordingly, when the icon corresponding to the application program that is not yet installed is selected from among the displayed icons, the control unit 120 downloads the corresponding application program from the server 200 and installs the downloaded application to the storage unit 110.

By contrast, when the icon corresponding to the old version of the application program is selected from among the displayed icons, the control unit 120 may update the old version of the application program installed to the storage unit 110 by downloading, from the server 200, latest version data or update data for the old version of the application program.

Meanwhile, the control unit 120 can be implemented such that the application program provided for the user terminal device 100 is confirmed only by selecting the icon container displayed in the screen. For example, the user terminal device 100 also offers a function, such as a Menu function, for allowing the user to confirm and select various functions. When the user selects the Menu function, all of the functions of the user terminal device 100 can be displayed as a menu tree. In so doing, the control unit 120 can hide a menu for the application programs of the first list. More specifically, the control unit 120 may control the display unit 130 not to include the functions for the application programs corresponding to the service hub program to the menu tree.

While it is not illustrated in FIGS. 3 and 4, the user terminal device 100 can further include a location calculation unit for calculating location information of the terminal device 100. The location calculation unit may calculate the location information using Global Positioning System (GPS) information or utilize location information obtained over a mobile communication network, such as a 3^{rd} Generation (3G) network. Alternatively, the location calculation unit may calculate the location information using a geomagnetic sensor of the user terminal device 100.

In this case, when the service hub program is initially executed, the control unit 120 can register the location of the user terminal device 100 by transmitting the current location information to the server 200. Thus, according to the location registered for the user terminal device 100, the server 200 can control to provide the service hub program and the application program to the corresponding user terminal device.

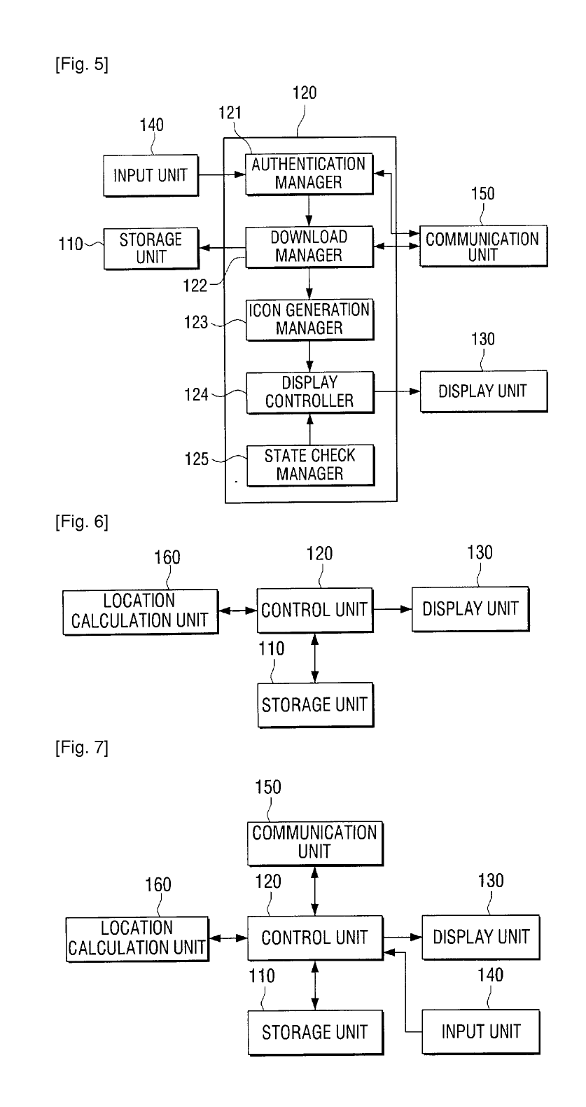

FIG. 5 is a detailed block diagram illustrating a user terminal device, according to an embodiment of the present invention. Referring to FIG. 5, the control unit 120 includes an authentication manager 121, a download manager 122, an icon generation manager 123, a display controller 124, and a state check manager 125.

The authentication manager 121 performs an authentication process with the server 200. In performing the authentication, the authentication manager 121 can send various information such as unique information, user information, and location information of the user terminal device, to the server 200.

The server 200 certifies whether the user corresponding to the user terminal device 100 is authorized to download the service hub program by checking the received information, determines whether the download is possible, and transmits the authentication result to the authentication manager 121. According to the authentication result, the authentication manager 121 determines whether to download the service hub program.

When the authentication manager 121 determines to download the service hub program, the download manager 122 sends a transmission request for the service hub program to the server 200. Hence, the service hub program is received.

When the service hub program is received, installed, and executed at the user terminal device 100, the download manager 122 can request information of the application program by transmitting, to the server 200, various information for specifying the user terminal device 100. The information for specifying the user terminal device 100 can be various information such as a user ID, password, unique information of the user terminal device, identification information (i.e., an application ID) of the service hub program, and version information.

When determining the authorized user by comparing the pre-registered information with the information received from the download manager 122, the server 200 can send the first list of the application programs corresponding to the user terminal device 100 and the service hub program, and the second list of the icons of the application programs. The download manager 122 receives the first list and the second list and manages the received lists.

In receiving and managing the lists as above, the download manager 122 may also be referred to as a hub application service list manager.

Meanwhile, the download manager 122 can protect the downloaded application program against access from other programs, such as a menu or a file manager. More specifically, the user cannot access the application program provided by the service hub through functions such as a menu function or a file search function, and can access only the application program through the service hub program. Through this restriction, the download manager 122 can hide the abovementioned application program from being displayed in the menu tree and can exclude the application program from being a target of a search. In this respect, the download manager 122 may also be referred to as a hub available secure folder manager, a secure manager, or a secure folder manager.

In the meantime, the download manager 122 is operated in a similar manner as a secure folder manager in the above description, but a secure folder manager may also be provided separately, irrespective of the downloading operation.

More specifically, the secure folder manager can make information such as an application list and an icon received from the server 200 unavailable to outside exposure. More specifically, such information may be stored in a hidden state.

In addition, a user may set or release a separate password for each application received through a service hub program. For example, a secure folder manager may add and display a separate menu for selecting a password setting function and a password releasing function in a service hub program menu.

If a user selects the separate menu, an area for setting or releasing a password with respect to various applications that are currently installed is displayed. The user may set a password by inputting the password in an area corresponding to a desired application or may release a password setting of a desired application by selecting a password-releasing button.

If a user makes a selection to use an application encrypted with a password, a User Interface (UI) for requesting an input of the password is displayed on a screen. The user may use the corresponding application only when the password is accurately input on the UI. As such, security may be further strengthened as a password is set for each application.

In the meantime, a password may be set or released with respect to all applications or use of a service hub program, instead of each application. For example, if a user selects an icon container, a UI for requesting an input of a password may be displayed on a screen. If a user inputs the password accurately, information regarding various applications corresponding to the relevant service hub program may be displayed.

In addition, a password may be set or released by group. More specifically, a plurality of applications may be classified into groups and a password may be set or released with respect to each group.

Further, a route or a method to access an application received via a service hub program as described above may be unified. More specifically, applications may be configured such that such operations as icon display, application execution, and application removal are performed only through a service hub program. In this case, a user may check information regarding applications received via a service hub program and select whether to execute an operation only when an icon container is selected on a screen.

As described above, a service hub program may perform various processing to maintain security of various information received via the service hub program.

The icon generation manger 123 downloads icon data from the server 200 based on the second list, i.e., the icon list. Hence, the icon generation manger 123 generates the icon container or the icon by managing the icon data. More specifically, the icon generation manger 123 generates the icon container including the icons for the application programs of the first list according to the second list.

The display controller 124 controls the display unit 130 to display the icon container in the screen. Accordingly, when the icon container is selected, the display controller 124 controls the display unit 130 to display the icons of the icon container.

The state check manager 125 changes the display state of each icon in the icon container according to the current installation state of the application program of the first list. More specifically, the state check manager 125 changes the display attribute, or additionally displays various word labels such as “New”, “Update”, and “No change”. For example, the word New can be added and displayed for the icon of the application program not installed, the word Update can be added and displayed in one side of the icon of the application program of the old version, and the words No change can be added and displayed for the icon of the application program of the latest version. These words are merely provided as examples, and other various expressions can be used in accordance with embodiments of the present invention. The display attribute can also include color, size, shape, location, etc.

Accordingly, the user can easily confirm the state of the application program provided in the service hub. When the user selects the icon, processing corresponding to the icon state is performed.

More specifically, when the icon of the application program that has not been installed yet is selected, the download manager 122 sends, to the download server 200, a download request for the application program corresponding to the relevant icon. Hence, the corresponding application program is downloaded and installed to the storage unit 110. When the icon corresponding to an old version of application program is selected, the download manager 122 sends an update request for the application program corresponding to the relevant icon, to the server 200. Hence, the latest version data or the update data is received, in order to update the application program pre-stored to the storage unit 110.

FIGS. 6 and 7 are block diagrams of various user terminal devices for providing a Location Based Service (LBS), according to an embodiment of the present invention.

An LBS is a service for limiting the availability for the service hub program or at least one of the application programs corresponding to the service hub program according to the location of the user terminal device.

Referring to FIG. 6, the user terminal device 100 includes a storage unit 110, a control unit 120, a display unit 130, and a location calculation unit 160. The storage unit 110, the control unit 120, and the display unit 130 operate in a manner similar to that described herein with reference to FIGS. 3, 4, and 5, and therefore, a further description of these elements is omitted for clarity and conciseness.

The storage unit 110 can store the service hub program, other programs, and data usable by the user terminal device 100.

The location calculation unit 160 calculates the location information of the user terminal device 100. As described above, the location information can be calculated using the GPS information, the location information obtained from the 3G network, and the location coordinates calculated by a geomagnetic sensor module of the user terminal device 100.

The control unit 120 supports the LBS based on the location information and the effective area information. More specifically, according to whether the location information falls outside of the effective area information, the availability of at least one of the application programs or the service hub program is limited, the authentication result is adjusted, or the location is registered. The LBS can be executed for secure restriction, such that the service hub operates only in a specific region requested by the corresponding organization, (i.e., operates only in the effective area).

For example, when the location of the user terminal device is in the effective area, the control unit 120 displays the icon container corresponding to the service hub program by normally executing the service hub program. When the corresponding icon container is selected, the control unit 120 displays the icons of the icon container in the screen. Hence, when one of the displayed icons is selected, the control unit 120 processes the new installation, the update, or the application execution, according to the state of the application program corresponding to the selected icon. More specifically, when the corresponding application program is normally installed, the control unit 120 executes the corresponding application program. When the corresponding application program has not been installed or an old version of the application program is installed, the control unit 120 newly installs or updates the corresponding application program.

By contrast, when the location of the user terminal device leaves the effective area, the control unit 120 disables the service hub program or at least one application program, according to embodiments of the present invention, or the setting state.

More specifically, when the service hub program is disabled, the control unit 120 can delete the icon container in the screen or display the icon container in the unselectable state.

Alternatively, even when the icon is selected, the control unit 120 can restrict the icon display.

When the application program is disabled, the control unit 120 can delete or display the icon in the unselectable state by disabling all or part of the application programs for the corresponding service hub.

The effective area information can be frequently set or changed in a webpage provided from the server 200, and a plurality of the effective areas can be set.

The authentication and/or the use of only a particular application program of the multiple application programs may be restricted according to the location information.

When there are a plurality of effective areas as described above, the authentication and/or the use of the different application program may be restricted per effective area.

For example, when the application programs for the service hub are a1, a2, a3, b1, b2, c1, and c2, only a1, a2, and a3 can be used in area A, only b1 and b2 can be used in area B, and only c1 and c2 can be used in area C.

The operations of the control unit 120, based on the location information, may be performed by the user terminal device 100 itself, and controlled with the intervention of the server 200.

An example in which the user terminal device 100 provides the LBS is described in greater detail below.

When the service hub program is executed, the user terminal device 100 receives the effective area information from the server 200. The user terminal device 100 may receive effective area information every time the service hub program is executed, when the effective area is changed after a single reception in the initial execution, or periodically.

The control unit 120 checks whether the user terminal device 100 is in the effective area by comparing the effective area information received from the server 200 with the location information. Hence, when the user terminal device 100 is in the effective area, the control unit 120 supports normal use of the service hub program and the application program as described above. By contrast, when the user terminal device 100 is outside the effective area, the control unit 120 limits the availability of the application program or the service hub program. Specifically, when a program is running, the control unit 120 automatically terminates execution of the corresponding program.

When an execution request for the program of the limited availability is received, the control unit 120 ignores the execution request. When the availability is limited, the display state of the icon container or the icon can be displayed in the inactivated state as described above. In this case, when the available application program exists, the activated icon of the application program can be retained.

Secondly, the server 200 can provide the LBS. In this case, the user terminal device 100 can transmit its location information to the server 200 periodically or every time a particular event takes place.

The server 200 determines whether the service is supportable by comparing the effective area information set by the organization with the location information. Hence, the server 200 transmits the availability information so that the user terminal device 100 limits the availability according to the information.

The availability information can be information that sets the application programs and the service hub program to the available state when the location of the user terminal device is in the effective area, and sets at least one of the application programs and the service hub program to the unavailable state when the location of the user terminal device is outside the effective area.

The availability information can be in the form of a list of unavailable application programs. The corresponding list includes information relating to the forbidden application program outside the effective area from among the application programs provided for the corresponding service hub.

The control unit 120 limits the availability of the application programs of the list. When all of the application programs are unavailable, the control unit 120 may limit the availability of the service hub program.

The control unit 120 may control the display unit 130 to display the icon, or the icon container, for the unavailable application program, in the inactivated state.

As described above, when the service hub program is initially executed, the control unit 120 sends and registers to the server 200, various information such as, for example, location information of the user terminal device at the initial execution point of the service hub program, and unique information of the user terminal device.

Using the received location information, the server 200 determines whether the corresponding user terminal device lies in the effective area. Only when the user terminal device stays in the effective area, the server 200 can transmit the service hub program or the application program. Specifically, the authentication fails outside the effective area.

The server 200 is also able to consider the time. Specifically, the server 200 may register the corresponding user terminal device only when the service hub program is executed during a preset time period, starting from the service hub registration or the conclusion or validation of the contract with the organization.

FIG. 7 is a block diagram of another user terminal device for providing the LBS, according to an embodiment of the present invention.

Referring to FIG. 7, the user terminal device includes the storage unit 110, the control unit 120, the display unit 130, the input unit 140, the communication unit 150, and the location calculation unit 160.

As described above with respect to FIG. 4, the communication unit 150 is connected to the server 120 and can transmit and receive programs and data. The input unit 140 can receive various information or commands from the user.

The components of FIG. 7 are the same as those of FIG. 4, except for the location calculation unit 160, and operations of the components are the same as that described with respect to FIG. 4, except for the operation relating to the LBS.

As shown in FIGS. 6 and 7, the LBS can also be executed in the user terminal device of FIGS. 3 and 4.

In this case, the location information calculated by the location calculation unit 160 can be transmitted to the server 200 to register the location, as described above. Thus, the service hub program and application program configuration from the server 200 can be automatically carried out.

According to the execution of the service hub program, the control unit 120 of the user terminal device 100 can include a component for supporting the LBS, which is described in greater detail below.

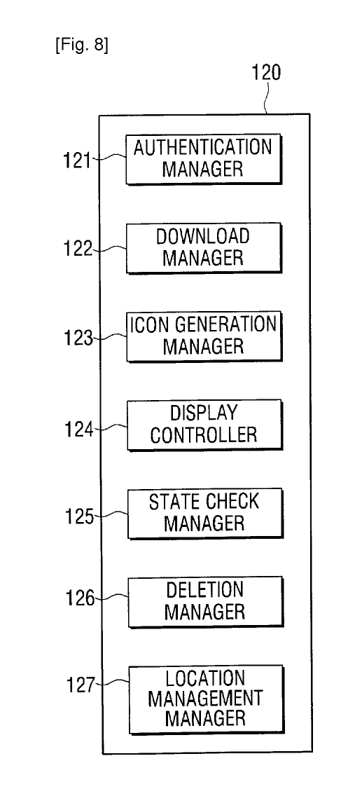

FIG. 8 is a diagram illustrating a structure and operations of the user terminal device for managing according to the state change of the user or the user terminal device, according to an embodiment of the present invention.

Referring to FIG. 8, the control unit 120 of the user terminal device 100 can include the authentication manager 121, the download manager 122, the icon generation manager 123, the display controller 124, the state check manager 125, a deletion manager 126, and a location management manager 127.

The location management manager 127 provides the aforementioned LBS. In various embodiments of the present invention, the location management manager 127 may be omitted from FIG. 8 or equipped and used together with the deletion manager 126 of FIG. 8.

The components of the control unit 120, excluding the deletion manager 126 and the location management manager 127, are the same as those in the control unit 120 of FIG. 5.

The deletion manager 126 can delete or disable the service hub program, at least one application program, and data, according to the state change of the user or the user terminal device.

For example, the deletion manager 126 can receive a list of programs to delete from the server 200 and delete the application programs of the list. In this case, the deletion manager 126 can request the list of the programs to delete from the server 200 every time the service hub program is executed.

Alternatively, the deletion manager 126 can periodically receive the list of the programs to delete from the server 200 using a separate daemon program for checking whether to delete the program.

The list of the programs to delete can be generated based on the application list provided from the user terminal device 100. Specifically, the deletion manager 126 sends the list of the applications installed to the user terminal device 100, i.e., the first list pre-downloaded, to the server 200 together with the terminal unique information and the user information. The server 200 selects the application program to delete from the first list received, and then sends the list to the user terminal device 100. Hence, the deletion manager 126 can delete the application program in the list.

Alternatively, the deletion manager 126 may transmit only the terminal unique information or only the user information to the server 200, and receive and delete the list of the application program to delete as determined from the server 200.

For example, the deletion manager 126 may delete every application program corresponding to the service hub or the service hub program, according to an instruction from the server 200.

Specifically, a wipe-out can be requested to the server 200 when the state is changed to jeopardize the security maintenance, for example, when the user resigns or does not belong to the organization any more for a certain reason, or when the user terminal device is lost. For the wipe-out request, the server 200 sends a deletion instruction for the service hub program or a deletion program for the entire application program to the deletion manager 126. The deletion instruction may be referred to as a wipe-out instruction.

The deletion manager 126 can check whether the wipe-out instruction is received from the server 200 every time the service hub program is executed.

Alternatively, the deletion manager 126 may periodically check whether the wipe-out instruction is received, using a separate daemon program.

Upon receiving the wipe-out instruction, the deletion manager 126 can delete every program and data. The deletion manager 126 may delete the icon container and the icon display together.

As described above, the deletion manager 126 may perform a kill function for individually deleting the application programs, or a wipe-out function for deleting all of the application programs or the service hub program and the data all together.

The kill function and the wipe-out function can be applied separately or together.

Specifically, the deletion manager 126 may include a kill manager for conducting the kill function and a wipe-out manager for conducting the wipe-out function.

Thus, the security for the service can be maintained definitely.

While the kill function and the wipe-out function may be performed according to the request of the organization or the user for the server 200, they can be performed in cases of location secession or authentication failure of the user terminal device 100.

Specifically, the kill or wipe-out function can be executed also when the user terminal device 100 leaves the effective area for a preset time or fails the authentication or the user identification a preset number of times. As a result, it is possible to prevent an unauthorized third party from using the hub service.

The operations of the deletion manager 126, specifically, the kill function and the wipe-out function can be executed by the control unit 120.

The control unit 120 can receive the list of the application programs to delete or the wipe-out instruction from the server 200 via the communication unit 150. Hence, the program or the data stored to the storage unit 110 can be deleted.

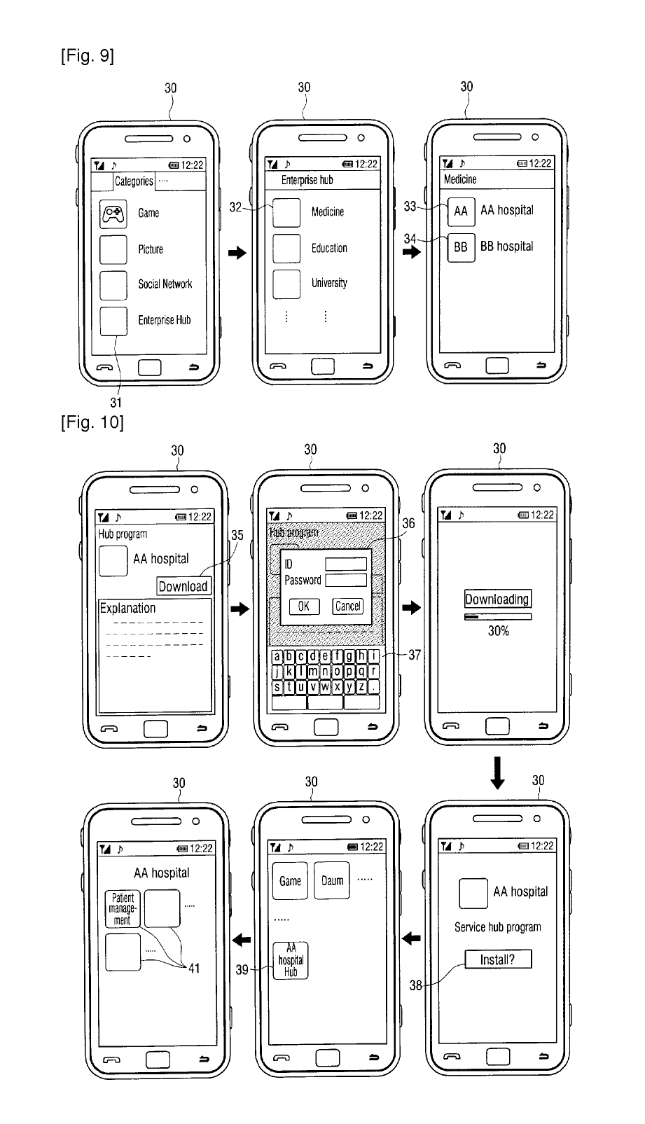

FIGS. 9 and 10 are diagrams illustrating a method for downloading the service hub program in the user terminal device, according to an embodiment of the present invention.

Referring to FIG. 9, when the user terminal device accesses the server, such as, for example, application store, a screen 30 can display categories for the application programs. The user can select a menu 31 such as, for example, Enterprise Hub supporting the hub service, in the screen 30. Hence, the user terminal device is connected to the server 200 that provides the hub service.

Using page data provided from the server 200, the user terminal device displays a screen showing groups 32 for distinguishing the organizations of which the service hub is registered. In FIG. 9, the screen 30 displays the groups 32 including Medicine, Education, University, etc.

In this state, when one group 32 is selected, information 33 and 34 relating to the organization of the registered service hub among the organizations belonging to the group 32, are displayed in the screen 30. Specifically, in the Medicine field, an AA hospital and a BB hospital contract with the server 200 to receive the hub service. In the screen 30, the user selects his/her organization.

When the user is a worker of the AA hospital and selects an AA hospital menu 33, the screen is changed as shown in FIG. 10.

Referring to FIG. 10, the screen 30 for downloading the service hub program for the AA hospital is displayed. In the screen 30, the user may obtain information of the service hub program, and request the download by selecting a download menu 35.

When the download menu 35 is selected, the screen 30 displays a pop-up window 36 for inputting the user information. An input window such as soft keyboard 37 can be displayed together with the pop-up window as shown in FIG. 10. Alternatively, the user may input an ID and a password using a touch pen on the pop-up window 36. This user information can be provided from the server 200 for the organization after contracting between the server 200 and the organization, or directly designated by an operator of the organization. The operator of the organization can notify the users belonging to the organization of the user information in written, mail, or text message form.

When the user information is input, the user terminal device 100 performs the authentication by transmitting the user information and the unique information of the user terminal device 100 to the server 200. The unique information, as aforementioned, can be the IMEI, the MSISDN, and the like.

Accordingly, when the authentication is successful, the download of the service hub program is initiated. During the download, a message indicating the downloading degree can be displayed in the screen 30. When the download is completed, the screen 30 displays a message inquiring about whether to install the service hub program. When the user selects an Install menu 38 in the screen, the service hub program is installed to the user terminal device 100 and the screen 30 displays an icon container 39.

When the icon container 39 is selected, all icons 41 in the icon container 39 are displayed. As described above, the display state of the icons 41 can be altered according to an installation state and version information of the application program, which has been described in detail above.

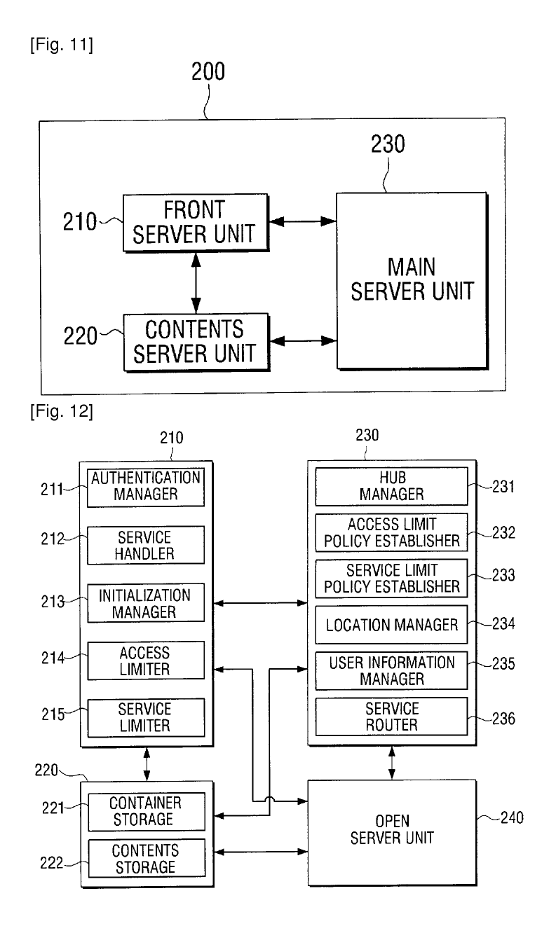

FIG. 11 is a block diagram of the server, according to an embodiment of the present invention.

Referring to FIG. 11, the server 200 includes a front server unit 210, a contents server unit 220, and a main server unit 230.

The contents server unit 220 stores the service hub program and the application programs, which are explained in greater detail with reference to FIG. 12. The front server unit 210 manages authority of the application program for providing the service per enterprise and per business, and performs a preprocessing function, such as, for example, initialization, authentication, and policy execution and management. The front server 210 routes the service to the contents server unit 220 according to the service type based on the contract.

Specifically, when the user terminal device is connected, the front server unit 210 authenticates whether the user terminal device is pre-registered, and then processes to provide the adaptive service hub program and the application programs to the user terminal device, which shall be explained greater detail with reference to FIG. 12.

When the authentication is successful, the main server unit 230 controls the front server unit 210 to transmit the service hub program, corresponding to the user terminal device, and the application programs, corresponding to the service hub program and the user terminal device, among the service hub programs and the application programs stored to the contents server unit 220, to the user terminal device.

The service hub program, as described above, indicates the program adaptively generated for the organization, according to the request of the organization of the user of the user terminal device. When the service hub program is installed to the user terminal device, the icon container is generated in the screen of the user terminal device.

At least one application program provided for the user terminal device indicates the program to selectively use for the service hub program and the user terminal device. This setup of the application program can be performed by the main server unit 230. Specifically, the administrator of the server 200 or the organization operator who accesses with a server account assigned by the server 200 can access the main server unit 230, request to generate the service hub, and set the application program.

The main server unit 230 generates the service hub when the service is requested, and sets the service hub program and the application program corresponding to the service hub.

In this case, the main server unit 230 may allocate the server account to the organization that requests the service, and may provide a server capacity so that the organization operator accessing with the server account directly can set and manage the service hub program and the application program, which is described in greater detail below.

Alternatively, the main server unit 230 can adaptively generate the service hub program for the organization based on the information provided from the organization, and directly set the application programs to be provided to the users of the organization.

When the user terminal device receives the location information at the point of the initial execution of the service hub program, the main server unit 230 can set the service hub program to be used in the user terminal device and the application program to be managed by the corresponding service hub program, using the location information and other unique information. Specifically, in the initial execution at the location of the organization A, the main server unit 230 can set the service hub program and the application program corresponding to the organization A.

When load occurs in a particular user party, the main server unit 230 can establish a policy for limiting the access of the user terminal device belonging to the user party. The user party can be the organization of the user, or the group of the user in the organization. The group can be divided into the departments or the divisions of the organization structure, and may be divided based on other criteria, such as, for example, based on various criteria including position, gender, age, marital status, and blood type. The main server unit 230 can limit access based on reasons other than the load. Specifically, when the contract from a particular organization is not complied with, the service suspension is requested, or the organization is dissolved, the main server unit 230 can establish the policy for limiting the access for the user terminal device registered to the corresponding organization. When the user terminal device registered in the user party of the limited access attempts the access, the front server unit 210 ignores the attempt and does not allow the access according to various policies established by the main server unit 230.

When the load occurs in a particular service, the main server unit 230 may establish a policy for limiting the corresponding service. Specifically, when application programs for providing a group mail service and a train ticket reservation service are excessively executed and subject to the overload, the main server unit 230 can control not to execute the application programs supporting the corresponding services when they are selected, or does not support the server operation in association with the application programs. According to the service restriction policy established by the main server unit 230, the front server unit 210 can limit the service for each user terminal device.

When the location of the user terminal device leaves the effective area, the main server unit 230 can be set to disable the service hub program for the user terminal device or at least one application program for the service hub program. Specifically, the main server unit 230 can provide the LBS. According to the setup state of the main server unit 230, the front server unit 210 can generate the unavailable list or the availability information, and send it to the user terminal device 100.

When the state of the user terminal device 100 is changed, the main server unit 230 can set the kill function for deleting at least one of the application programs provided to the user terminal device 100, or can set the wipe-out function for deleting at least one of every application program provided to the user terminal device 100, the service hub program, and the data generated in every program execution. According to the set function, the front server unit 210 can send the kill instruction or the wipe-out instruction to the user terminal device 100. The state change can be received from the operator of the organization or the user online or offline. Such a state change can include a personal state change, such as, for example, a job change, a retirement, transfer, or a time-off of the user, and a state change such as loss, breakdown, or replacement of the device.

The main server unit 230 can support various functions per service hub. For example, the main server unit 230 can calculate the service usage on a particular user basis and provide information of the service usage. Specifically, the information of the service usage can be provided directly to the user terminal device 100 via the front server unit 210, or the main server unit 230 can provide the information of the service usage directly to the terminal of the organization operator. The information of the service usage can be information relating to the current download state, the frequency of use, the use time, and the use cycle of the service hub program or the application program per organization, that is, per enterprise, per service group, and per user. The main server unit 230 defines various events as the indicator for obtaining the service usage. For example, the main server unit 230 can define the events such as download, execution, and execution end. In the service operation, the main server unit 230 catches the event occurrence according to the definition. Accordingly, the main server unit 230 calculates the information of the service usage by analyzing event logs, a database, and server logs. Hence, the service usage and the task progress per user and per organization in the organization can be easily monitored in view of the administrator.

For example, the main server unit 230 can also support the group mail service. When the operator of the organization, the administrator of the server, or the user terminal device generates and requests to send the group mail by designating a particular user party and requests to send the group mail, the main server unit 230 can set to transmit messages to the user terminal devices corresponding to the corresponding user party using the pre-registered user information. The front server unit 210 transmits the corresponding group mail to the user terminal device set by the main server unit 230.

In addition, even when a notification message is generated, the main server unit 230 can set to send the notification message to the user terminal devices having the reception entitlement for the notification message. Hence, the front server unit 210 can send the notification message.

As described above, the main server unit 230 and the front server unit 210 can provide various services, if necessary.

FIG. 12 is a detailed block diagram illustrating the server, according to another embodiment of the present invention. Referring to FIG. 12, the server 200 includes the front server unit 210, the contents server unit 220, the main server unit 230, and an open server unit 240.

The front server unit 210 includes an authentication manager 211, a service handler 212, an initialization manager 213, an access limiter 214, and a service limiter 215.

The authentication manager 211 performs authentication by receiving unique information of the device and the user information from the user terminal device 100.

In detail, the authentication manager 211 can carry out the authentication by decoding and restoring the received information, comparing the information with the information provided from the organization, and determining whether the corresponding device is the device registered by the organization which requests the hub service. Hence, when determining the registered device, the authentication manager 211 sends the authentication result to the user terminal device 100. While the authentication manager 211 can inquire about the information provided from the organization to the main server unit 230, the authentication manager 211 may fulfill the authentication by using the information stored to the open server unit 240 to reduce the load of the main server unit 230.

The service handler 212 manages the various services provided to the user terminal device 100. The service handler 212 can divide the service between different devices according to the type of the hub service. More specifically, when receiving the transmission request from the user terminal device that receives the authentication result, the service handler 212 transmits the service hub program corresponding to the user terminal device. The service hub program is adaptively generated for the service hub of the registered user terminal device. The service hub program can partially change some functions of the program, the webpage skin, and the available application programs in accordance with the nature of the organization, and other program basic structures can be the same.

More specifically, when the user terminal device accesses and is authenticated by the authentication manager 211, the service handler 212 routes the service hub program and the application program corresponding to the user terminal device from the contents server unit 220 to the user terminal device.

The initialization manager 213 performs the initialization when the service hub program is initially executed to access the user terminal device. Specifically, in the initial access of the user terminal device, the initialization manager 213 generates the application list and the icon list using the information registered to the open server unit 240 or the main server unit 230, and registers the terminal unique information such as IMEI received from the user terminal device 100, to the open server unit 240 or the main server unit 230.

When the name or the organization of the user is changed or when the service hub is changed, the open server unit 240 may detect this change using information of its open hub manager and open user manager, and thus re-register the user information or the terminal unique information. Through the initialization manager 213, the user can obtain the exact authority in real time regardless of his/her company or region and easily acquire the list of the services to receive. The terminal unique information, such as IMEI, which is incomprehensible to the user, can be automatically registered to the server 200.

As for initial access of the user terminal device, the initialization manager 213 can store the unique information (e.g., IMEI) of the terminal not exposed to the user by mapping the unique information and the user information, and provide the container list of the corresponding service hub based on basic data of the open server unit 240 synchronized with the main server unit 230.

When receiving the check request for the application program download or update, the service handler 212 can generate the list of the application programs to newly download or to update and send the generated list to the user terminal device. Hence, upon receiving the download request or the update request for at least one application program of the list, the service handler 212 can transmit the requested application program or update data to the user terminal device.

According to various embodiments of the present invention, the service handler 212 may transmit the application programs of the application program list, that is, of the first list, to the user terminal device all at once. Alternatively, when receiving the download request or the update request for at least one of the application programs of the first list, the service handler 212 may transmit the at least one application program or the update data to the user terminal device.

As described above, the first list is the list of at least one application program to be provided for the user group or the user level among all of the application programs provided to the organization of the user of the user terminal device, and can be generated by the initialization manager 213.

It is not necessary for the first list and the second list to be generated by the initialization manager 213, and the service handler 212 or the main server 230 can generate the first list and the second list in various embodiments of the present invention.

When at least one of various source information, such as user terminal device, organization, group, and application program setup state, is changed, the first list and the second list can be regenerated according to the change.

When a particular user party suffers from the load, the access limiter 214 limits the access of the user terminal device belonging to the user party. Specifically, when an error occurs during the hub service, the access limiter 214 can control and manage the service support on the organization basis, that is, on the enterprise basis or on the group basis.

An access limit policy establisher 232 of the main server unit 230 can make and execute an access limit policy by registering the service hub to control. When the access limit policy is executed, the access limiter 214 restricts the access of the user terminal corresponding to the control target, according to the policy. Using the access limit policy, the overload or the error in the service of a particular enterprise can be addressed in real time, thus promptly preventing the error from spreading to other services. Hence, the use can be limited per organization or per group.

The front server unit 210 can include the service limiter 215 for limiting the service when the load occurs in a service limit specific service.

According to the service limit policy established by a service limit policy establisher 233 of the main server unit 230, when it is necessary to limit the access of the system for the contents server unit 220, the service limiter 215 restricts the access and blocks the service. Hence, the use can be limited per particular service.

The contents server unit 220 includes a container storage 221 and a contents storage 222.

The container storage 221 stores the service hub program corresponding to the hub service or the icon container information relating to the service hub program.

The contents storage 222 stores the application programs corresponding to the respective service hub programs and other contents.

The contents can be classified into various categories based on their attributes.

For example, the contents can be divided into common contents, such as, for example, a financial application and a personnel matter application, indicating general contents commonly used regardless of fields, industry contents indicating contents managed per specific industry field such as, for example, hospital, school, and enterprise, and special contents indicating contents developed and used for a particular enterprise.

For example, the contents can be divided and stored based on the fields, such as, for example, electronics, chemistry, hospital, and school.

The contents storage 222 can store a segment group list and contents of the corresponding organization using a hub ID allocated to a service hub newly registered. Hence, when the user terminal device accesses, the contents storage 222 can provide the stored contents.

The contents server unit 220 can include a contents generation manager, a service group and user manager, an authentication manager, and the like. Accordingly, before providing the contents, the contents server unit 220 can generate and provide contents corresponding to the user after the authentication.

The list for providing the contents can be provided from the front server unit 210 or the main server unit 230, and the contents server unit 220 may generate the list using the user information by itself and provide the corresponding program. Meanwhile, the open server unit 240 independently manages the information for the sake of the fast authentication per enterprise or per business. When the front server unit 210 requests various information for the authentication, the open server unit 240 can provide basic information using an open hub manager and an open user manager. The various information stored to the open server unit 240 can be synchronized with various data recorded to the main server unit 230, various data stored to the contents server unit 220, and various data received via the front server unit 210.

More specifically, the open server unit 240 stores backup information of at least one of the unique information of the user terminal device, the user information of the user terminal device, the service hub program information provided for the user terminal device, and the application program information for the service hub program, and provides the backup information as sharing information.

Specifically, when the main server unit 230 manages all information, the front server unit 210 needs to request the information from the main server unit 230 in every authentication.

The main server unit 230 is subject to the load. Hence, the open server unit 240 manages the backup information and provides the information when the authentication is conducted.

When the user terminal device 100 initially receives the user information input by the user or the unique information of the terminal device, the open server unit 240 provides basic information for generating the icon container.

In addition, the open server unit 240 can provide and share the enterprise information and the user information to and with an authorized external institution. An external institution such as, for example, an application developer, can expose necessary information to develop applications required for the organizations, using open API. Hence, since the open server unit 240 can support the external institution to easily develop the applications, enhancement of the application program can be activated.

The main server unit 230 includes a hub manager 231, the access limit policy establisher 232, a service limit policy establisher 233, a location manager 234, a user information manager 235, and a service router 236.

The hub manger 231 registers the service hub when the service is requested. The hub manager 231 may allocate the server account when an organization requesting the service intends to directly manage the service hub.

Specifically, when the organization requesting the service is in a certain scale, the organization may have a human resource capable of managing the service hub. In this case, the server account can be requested on the contract with the administrator of the server 200. Hence, the operator of the organization can access to its server account by inputting his/her ID and password in the webpage supported by the server 200. Thus, the operator can directly set the application program to use in the service hub of the organization, modify, add, and delete the information of the user or the user terminal device registered to the service hub, and set or utilize various services such as LBS, group mail service, and notification message service.

When the server account is allocated to the organization operator, a login page is displayed to the operator. Specifically, first page data for providing the login page to the operator of the organization is transmitted.

When the operator inputs identification information allocated to the organization in the login page, second page data for providing a management page adaptively generated for the organization is transmitted.

Herein, while the management page can be provided by the server administrator in the beginning, the organization operator can modify and edit the management page some time later. The management page can display various information. For example, the management page can provide at least one of a first region for reading the list of the available application programs of the organization, a second region for adding, modifying, and deleting the application program, a third region for reading member information registered for the organization, a fourth region for adding, modifying, and deleting the member information, a fifth region for classifying the members, and a sixth region for selecting the application program to be used by the classified member group.

The login page and the management page of a similar type can be provided to not only the organization operator, but also the server administrator. That is, in the contract with a small or medium-sized enterprise, or an individual having no sufficient human resource, the administrator of the server 200 can manage the service hub according to the request. In this case, the hub manager 231 can provide the same management page even when the administrator of the server 200 logs on.

The access limit policy establisher 232 makes the policy for limiting the access per organization or per group, and the service limit policy establisher 233 makes the policy for limiting the use per service. According to the policies established by the access limit policy establisher 232 and the service limit policy establisher 233, the access limiter 214 and the service limiter 215 of the front server unit 210 restrict the access and the service use of the terminal device.

The location manager 234 supports the location registration and the LBS. When the service hub program is initially executed in the user terminal device, the location manager 234 receives and registers the location information. Hence, the location information is referred to when the corresponding terminal device is authenticated or when the corresponding service hub program and application program are set.

When the location of the user terminal device leaves the effective area, the location manager 234 disables the service hub program or at least one application program for the service hub program with respect to the user terminal device. Herein, the effective area and the application program to be disabled can be changed by the request of the organization operator or the server administrator, or by changing the user information.

A plurality of effective areas can be defined, and different programs can be disabled in each effective area.

The user information manager 235 manages the information of the user or the user terminal device registered to the service hub. Specifically, the user information manager 235 can set the kill function and the wipe-out function according to the state change of the user terminal device or the user.

More specifically, the user information manager 235 can periodically check whether the state is changed, based on the user information frequently or periodically transmitted from the administrator of the server 200 or the operator of the organization, or based on the information transmitted from the user terminal device. Hence, when the state is changed, the user information manager 235 sets the corresponding function and the front server unit 210 takes the corresponding action.

The service router 236 routes the service to adequately provide the user terminal device with the adaptive service hub program and application program for the user terminal device. Specifically, when the authentication manager 211 of the front server unit 210 performs the authentication, and the service handler 212 routes the user information, the service router 236 sets the suitable service hub program and application programs. Hence, the service handler 212 can generate and send the list to the user terminal device.

As described above, the components of the server 200 provide the service hub. In FIG. 12, the disposition of the components is divided for ease in understanding, and not to limit the embodiments of the present invention.

The server 200 of FIG. 12 may be described with components including an interface unit, a storage unit, and a control unit. For example, the control unit can process all or part of the functions of the front server unit 210, the main server unit 230, and the contents server unit 220.

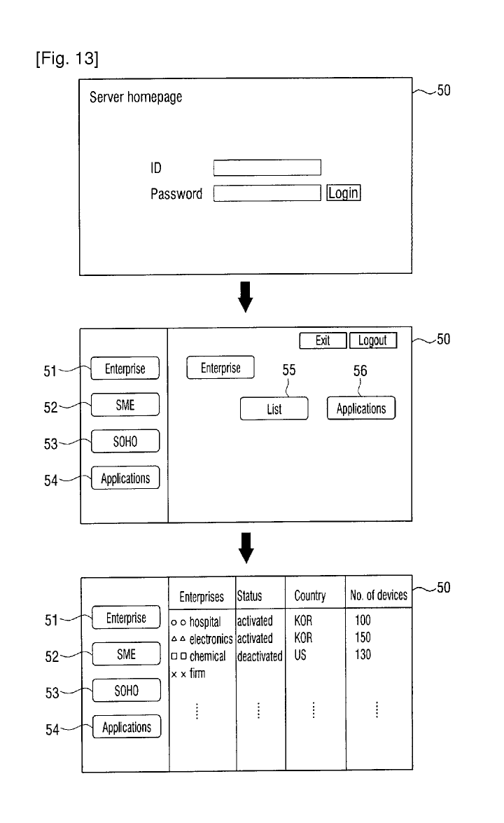

FIGS. 13 through 19 illustrate screens for registering and managing the service hub, according to an embodiment of the present invention.

Referring to FIG. 13, when the user accesses the webpage of the server through a terminal, such as, for example, a PC, a login screen 50 is displayed. Specifically, the server 200 transmits the first page data for generating the login page to the corresponding terminal. The user accessing the webpage of the server 200 is referred to as an operator.

When the user inputs his/her ID and password, the screen 50 is changed to a management page. The management page lists menus 51 through 54 for classifying clients of the supported hub server in one side, and displays a list menu 55 for checking a list of clients (enterprises) currently selected, and an applications menu 56 for checking the application programs supported for the client. The menus 51 through 54 can include an enterprise menu, a Small and Medium Enterprise (SME) menu, a Small Office/Home Office (SOHO) menu, which are divided based on the organization scale, and an application menu. The user can select one of the left menus 51 through 54 and then select the list 55 or the application menu 56.

When the list menu 55 is selected, the screen 50 displays detailed information such as list, status, nationality, and number of the devices registered, of the clients of the supported hub service.

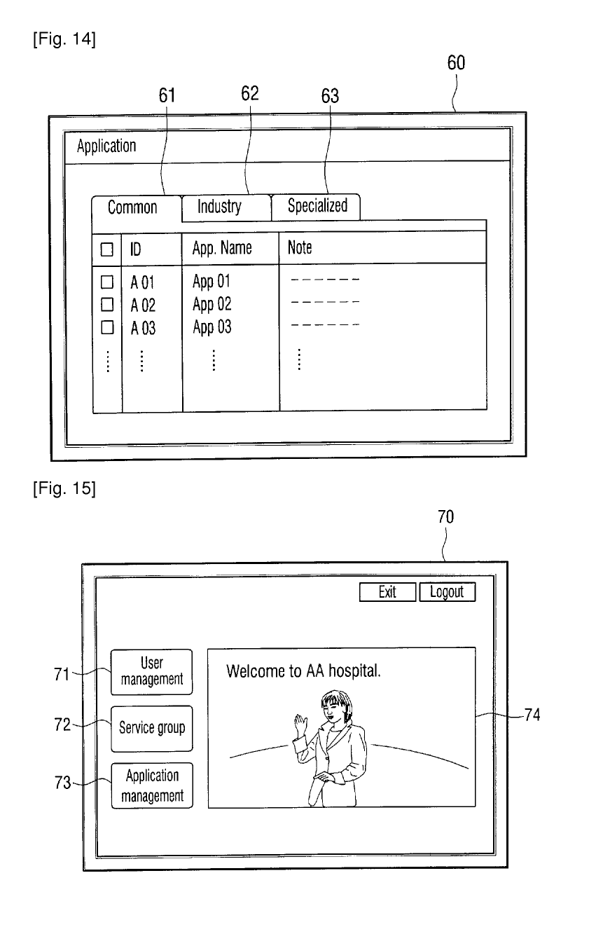

FIG. 14 depicts the state of a screen 60 when the application menu 56 is selected, according to an embodiment of the present invention.

Referring to FIG. 14, the application programs are classified and arranged into categories including Common 61, Industry 62, and Specialized 63.

When one category is selected, a list of the application programs of the selected category is arranged. The operator can select at least one of the application programs in the list and determine to support the selected application program.

The server 200 can allocate some server space to the organization operator as explained above. Hence, the operator of the organization can log in by inputting his/her allocated ID and password in the login page of FIG. 10.

FIG. 15 depicts the management page individually allocated and provided to the operator of the organization. As shown in FIG. 15, unlike the management page utilized by the administrator of the server, the management page provided to the organization operator is adaptively generated in the service hub.

In FIG. 15, menus including user management 71, service group 72, and application management 73 are displayed in an edge of the management page 70. An image adaptively generated in the service hub can be displayed on a center area 74 of a screen. The operator of the organization can arbitrarily change the image, and the location and the type of the menus 71, 72, and 73.

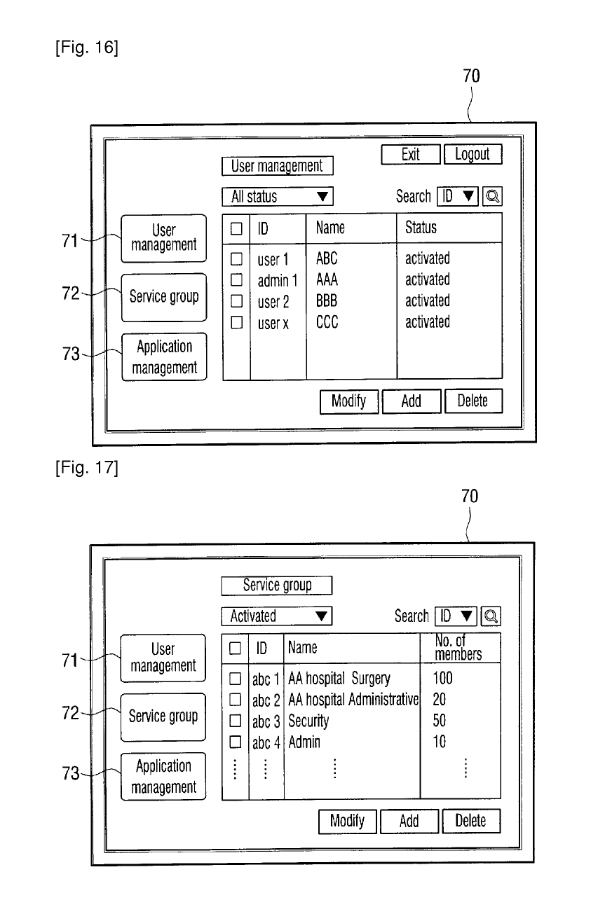

When the User management 71 is selected, the screen is changed as shown in FIG. 16.

Referring to FIG. 16, the screen displays information of the users registered to the service hub. While only ID, Name, and Status are depicted in FIG. 16, various other information, such as, for example, device information usable by each user, position, department, and gender, etc., can be displayed. The operator can select a particular user in the list and obtain detailed information of the user. Thus, the operator can change the status of the user. In this case, when the user is resigned, the operator can set the status of the user to the resignation. Accordingly, the server 200 intercepts the service provided to the user terminal device of the corresponding user. Specifically, the server 200 can send the kill instruction or the wipe-out instruction for deleting the program or the data individually or entirely.

When the operator changes the department of the user to another department, the server 200 newly generates the list of the application programs corresponding to the changed department and the relevant icon list, and provides the lists to the user terminal device 100. In addition, the server 200 sends the kill instruction for the unavailable application programs of the existing application programs. Hence, the user terminal device 100 can delete at least one of the existing application programs, and download or update the new application programs.

While the effective area is not illustrated in FIG. 16, the operator can also set the effective area. Specifically, when a particular user transfers from Seoul to Busan, the effective area can be changed from Seoul to Busan. As a result, the service use is limited in areas other than Busan.

The operator can easily modify, add, and delete the user in the list. Also, the screen can display a menu for sorting based on the status, or for searching, as shown in FIG. 16.

FIG. 17 shows a screen when the service group 72 is selected, according to an embodiment of the present invention. The service group 72 is divided based on the construction of the organization. When the organization is the hospital, as shown in FIG. 17, the service group is divided into departments (surgery, administrative, security, etc.). When the operator selects one service group in the list of FIG. 17, the information of the users belonging to the corresponding service group and the information of the application programs provided for the service group can be displayed. Hence, the operator can select the available application programs in the corresponding service group all together. When the user terminal device belonging to the corresponding service group executes the service hub program according to the selection of the operator, the server 200 can download or update the application programs of the service group all together or selectively.

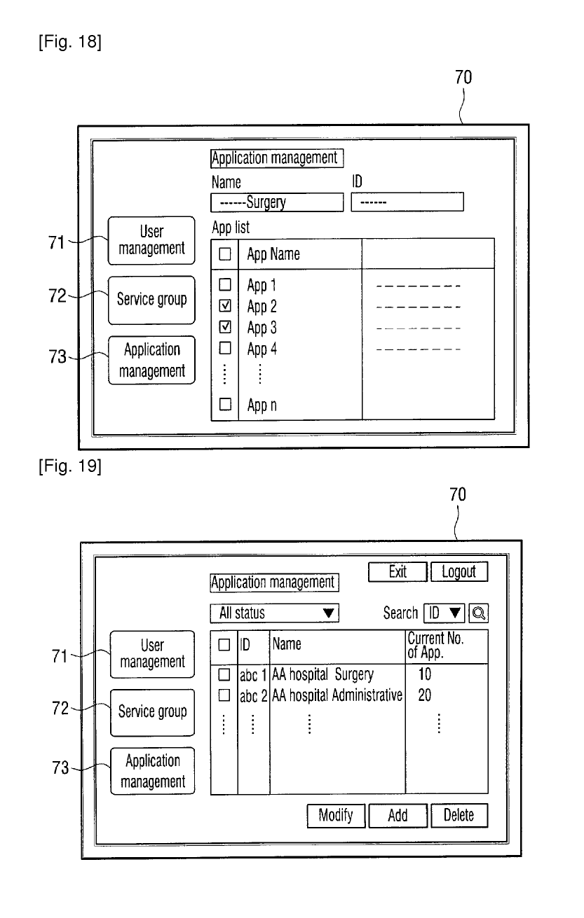

FIG. 18 depicts the application program management for a particular service group, according to an embodiment of the present invention. Specifically, when a particular service group is selected in the screen of FIG. 17, the screen of FIG. 18 can be displayed.

Referring to FIG. 18, a name and an ID of the selected service group are displayed at the top, and information of all application programs including the application program currently supported for the service group is displayed as the list. The operator can determine the application program to support in the service group by changing the selection status for each application program.

FIG. 19 shows the screen when the application management menu 73 is selected, according to an embodiment of the present invention.

Referring to FIG. 19, based on the sorting basis, all of the application programs, the application programs currently supportable, and the application programs per category can be displayed as the lists. The user can select the application program in the list and obtain the detailed information of the application program.

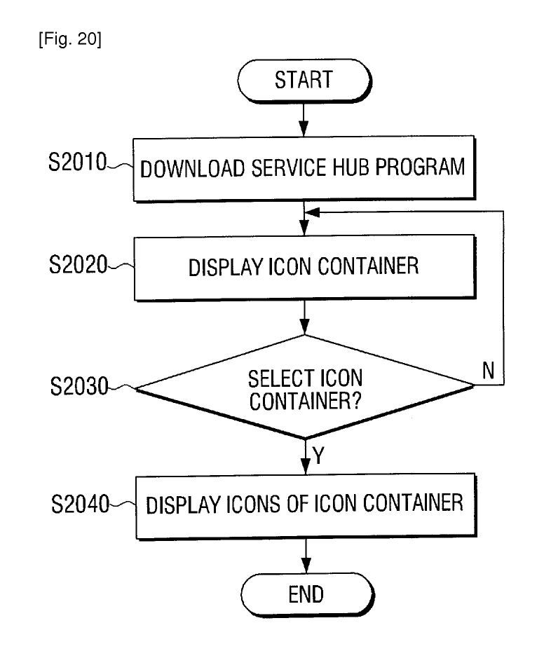

FIG. 20 is a flowchart illustrating a service providing method of the user terminal device, according to an embodiment of the present invention.

Referring to FIG. 20, the user terminal device downloads the service hub program by accessing the server, in step S2010. In so doing, the authentication and the location acquisition can be performed.

Accordingly, the user terminal device displays the icon container by installing the downloaded service hub program, in step S2020. In step S2030, it is determined whether an icon container is selected. When the icon container is selected, the icons of the icon container are displayed, in step S2040.

The icons in the icon container indicate the icons of the service hub of the registered user terminal device and the application programs for the service group. Specifically, when or before the icon container is selected, the user terminal device can provide the icons by receiving the first list relating to the application programs and the second list relating to the icons from the server.

When the icon is selected, the user terminal device can execute the application program corresponding to the selected icon, or download or update the corresponding program.

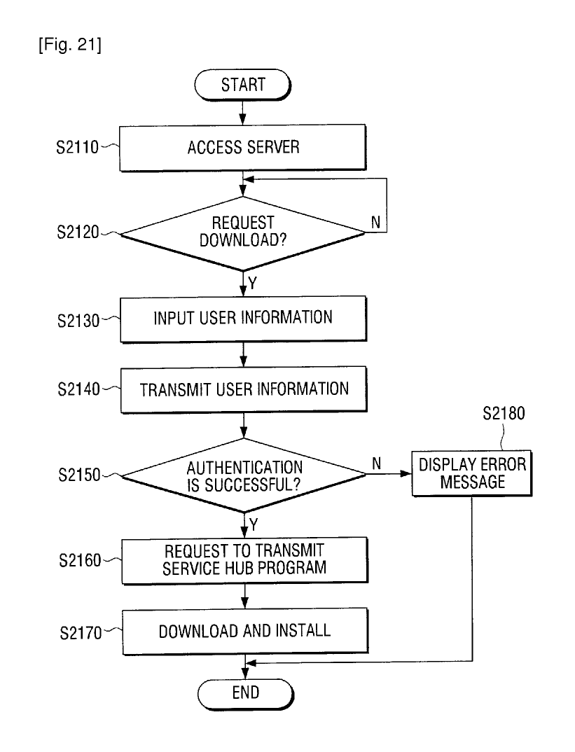

FIG. 21 is a flowchart illustrating a method for downloading the service hub program, according to an embodiment of the present invention.

Referring to FIG. 21, when accessing the server, in step S2110, the method generates the screen according to the page data provided from the server. In step S2120, it is determined whether the user selects the service hub program to download in the screen and requests to download the service hub program.

When the download is requested, the method receives the user information by displaying the screen requesting the user information, in step S2130, and sends the input user information to the server, in step S2140. The server performs the authentication using the received user information.

In step S2150, it is determined whether the authentication is successful. When the authentication is successful, the user terminal device sends the service hub program transmission request to the server, in step S2160, and downloads and installs the service hub program, in step S2170.

When the authentication fails, the user terminal device displays an error message, in step S2180.

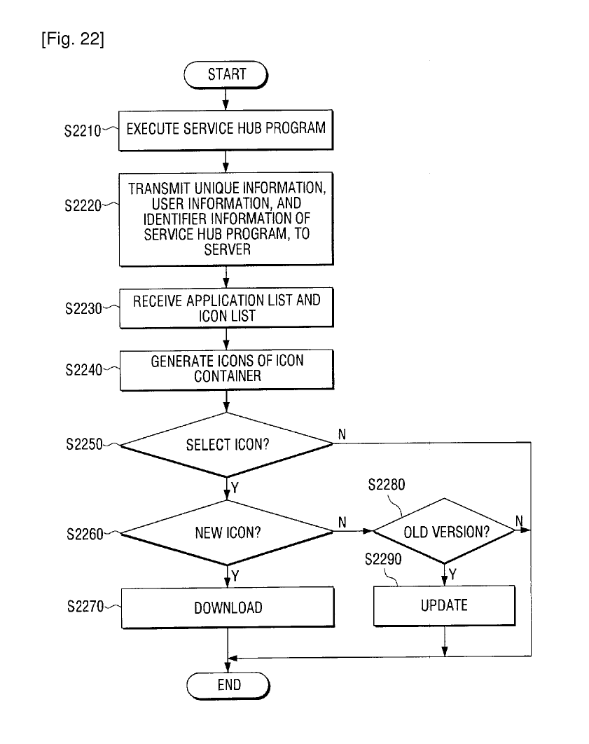

FIG. 22 is a flowchart illustrating a method for displaying the icon of the user terminal device, which installs the service hub program, according to an embodiment of the present invention.

Referring to FIG. 22, when the service hub program is executed, in step S2210, the user terminal device transmits the unique information, the user information, and the identifier information of the service hub program to the server, in step S2220.

Hence, the user terminal device receives the list of the application programs and the list of the icons, in step S2230.

When the icon container is selected, the user terminal device generates and displays the icons contained in the icon container, in step S2240. At this time, the user terminal device changes the display status of the icons by checking the installation and the version information of each application program.

In step S2250, it is determined whether the user selects an icon. When the user selects the icon, the user terminal device performs the adaptive process according to the status of the application program corresponding to the selected icon.

When the user selects an icon, it is determined whether it is a new icon, in step S2260. For a new icon, the user terminal device downloads and installs the corresponding application program from the server, in step S2270.

For an existing icon, it is determined whether it is an old version, in step S2280. For the old version, the user terminal device updates the existing application program by requesting the update to the server, in step S2290.

By contrast, when the application program of the latest version is already installed, the user terminal device immediately executes the application program corresponding to the icon so that user can use it.

The download of the application program is in FIG. 22, and the application programs can be downloaded or updated all together as mentioned above.

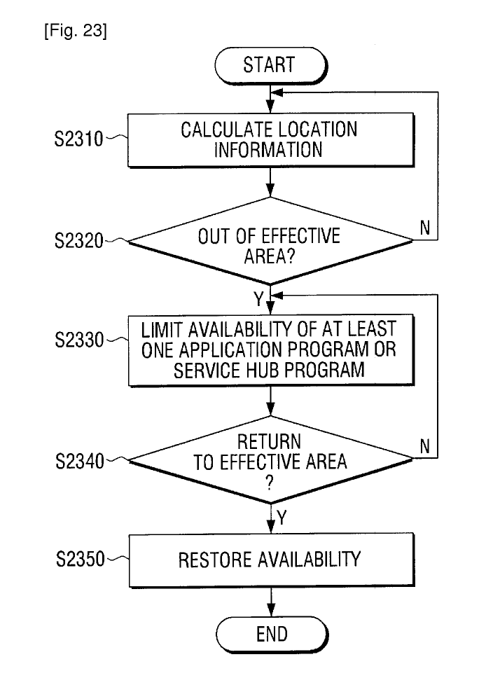

FIG. 23 is a flowchart illustrating a service providing method of the user terminal device for providing the LBS, according to an embodiment of the present invention.

Referring to FIG. 23, upon calculating the location information, in step S2310, the device determines whether the user terminal device leaves the effective area, in step S2320.

The subject of this determination can vary in various embodiments of the present invention. Specifically, the user terminal device receiving the effective area information from the server can directly determine, or the user terminal device may transmit the location information to the server, and the server may determine by comparing the location information with the registered effective area information.

When the user terminal device leaves the effective area, the device limits the availability of at least one application program or the service hub program, in step S2330. The availability can be limited variously according to various embodiments of the present invention. The device can limit the use by receiving the availability information from the server or by receiving the list of the programs to disable. Alternatively, the user terminal device may disable a particular program by itself by referring to preset application program information.

In step S2340, it is determined whether the user terminal device returns to the effective area. When the user terminal device returns to the effective area, the user terminal device restores the availability of the disabled programs, in step S2350. The restoration can be instructed by the intervention of the server, or determined by the user terminal device itself according to embodiments of the present invention.

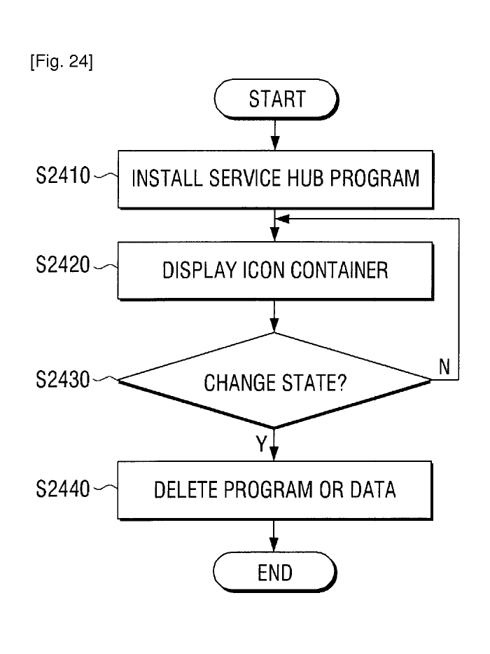

FIG. 24 is a flowchart illustrating a method for changing the service according to the state change.

Referring to FIG. 24, when the service hub program is installed, in step S2410, the icon container is displayed, in step S2420. In step S2430, it is determined whether the state is changed. When the state is changed, the user terminal device can delete at least one of the program and the data, in step S2440. In this case, the user terminal device can delete only some of the application programs, or delete all of the application programs or the service hub program and the data generating in the program execution all together. This operation can be carried out according to the instruction of the server.

While the deletion is illustrated in FIG. 24, it is not necessary to delete the program, and instead the program can be processed as an unavailable state.

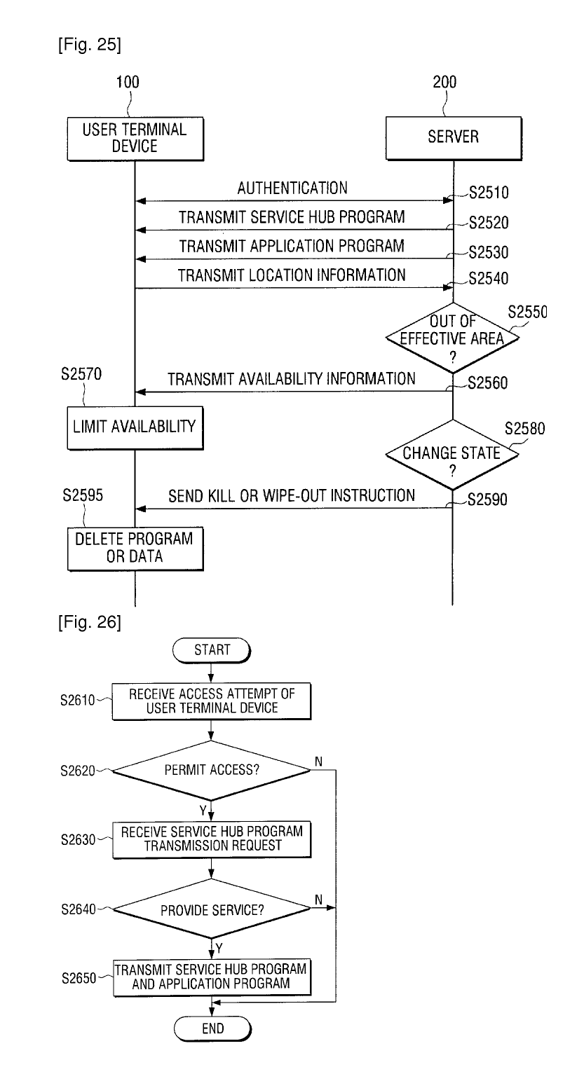

FIG. 25 is a sequence diagram for illustrating the operations between the user terminal device 100 and the server 200.

Referring to FIG. 25, when authentication is conducted between the user terminal device 100 and the server 200, in step S2510, the service hub program is transmitted from the server 200 to the user terminal device 100, in step S2520. The application programs are transmitted all together or selectively from the server 200 to the user terminal device 100, in step S2520.

When an agreement is made in advance between the organization and the server 200, and the server 200 and the user terminal device 100 are of the same manufacturer or in a particular contract, the user terminal device 100 sold to the organization may contain the service hub program and the application programs in advance at the point of the release.

As such, when various application programs are installed, the user can use each application program using the service hub program, that is, using the icon container. As stated earlier, the application program cannot be hidden such that it is not displayed by a menu or file manager but is revealed only when the icon container is executed according to various embodiments of the present invention.

The user terminal device 100 and the server 200 can provide various adaptive services to the service hub.

Specifically, the user terminal device 100 sends the location information to the server 200, in step S2540, and the server 200 determines, using the location information and the effective area information, whether the user terminal device 100 leaves the effective area, in step S2550. Hence, the server 200 sends the availability information to the user terminal device 100, in step S2560.

The user terminal device 100 limits the availability of the programs according to the availability information, in step S2570.

The server 200 determines whether the state of the user or the user terminal device has changed, in step S2580. When the state of the user or the user terminal device 100 has changed and it is necessary to limit the service use, the server 200 can send the kill instruction or the wipe-out instruction to the user terminal device 100, in step S2590. Thus, the user terminal device 100 can delete the program or the data, in step S2595.

FIG. 26 is a flow diagram illustrating the service providing method of the server, according to an embodiment of the present invention. Referring to FIG. 26, upon receiving the access attempt from the user terminal device, in step S2610, the server determines whether to permit the access, based on the relevant policy, in step S2620. Specifically, the server blocks the access attempt of the user terminal device belonging to the access-limited organization or the organization of the unregistered service hub.

When permitting the access, the transmission request for the service hub program is received, in step S2630. The server determines, based on the service limit policy, whether to block the service, in step S2640. Hence, when determining to provide the service, the server transmits the service hub program and the application programs, in step S2650.

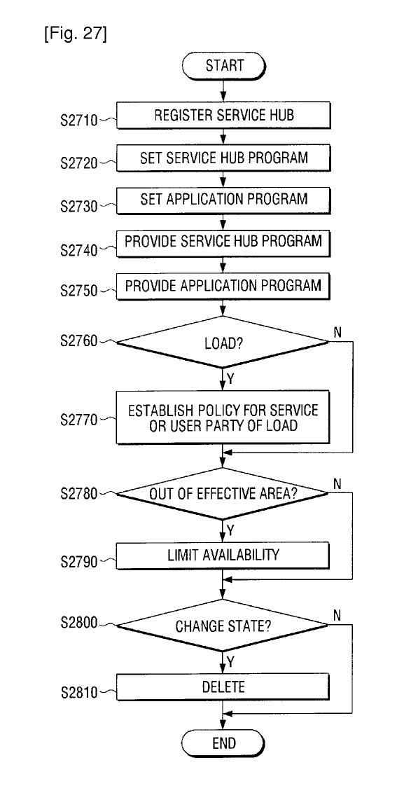

FIG. 27 is a flow chart illustrating the service providing method of the server, according to an embodiment of the present invention. Referring to FIG. 27, when the service hub is registered, in step S2710, the server sets the corresponding service hub program, in step S2720. The server sets the application programs, in step S2730. Without the separate setting, all of the default application programs can be set for the corresponding service hub program, and only the application programs selected by the server administrator or the organization operator may be set.

When the user terminal device accesses, the server provides the service hub program, in step S2740 and provides the application programs, in step S2750. Before providing these programs, authentication can be performed.

In step S2760, it is determined whether the load occurs. When the load occurs in a particular user party or in the service use, the server establishes the limit policy for the service or the user party of the load, in step S2770. When the terminal device requesting the service or the terminal device belonging to the user party requests the access or the program download, the server blocks the attempt.

The server frequently or periodically checks whether the user terminal device leaves the effective area, in step S2780, and limits the availability when the user terminal device leaves the effective area, in step S2790.

The server may frequently or periodically check whether the state is changed, in step S2800, and deletes the program and at least one of the contents when the state is changed, in step S2810. As such, the server provides various services to each user terminal device registered to the service hub at once and blocks the service use if necessary so that the users of the user terminal devices can easily utilize the device while maintaining the security.

So far, while the service hub program and the application program are mainly explained, the provision for the service hub is not limited to the service hub program and the application program. Specifically, basic contents, such as general data, can be provided per service hub and per service group.

The information of the organizations provided with the service hub may be shared with the authorized external institution so that the external institutions can develop the usable application programs for the service hub and the organizations and register them to the server. The server 200 can store the registered program to the contents server unit 220 and the open server unit 240 and provide the program to the service hubs if necessary, to thus reinforce the serviceability of the service hub.

Specifically, the application program developer freely develops the application program using the various sharable information provided from the server and registers it to the server. The server allocates the ID to the registered application program and manages the application program. The server allocates the service hub ID to the organization requesting the service and registers the service hub. In particular, the server allocates the server space to the organization or the individual which intents to manage by itself and allows the direct management. By contrast, the server may directly manage for the organization or the individual that wants the management agent.

As described above, the service provided from the server targets the organization such as enterprise.

Hence, this service may be referred to as a Business to Business (B2B) service.

Meanwhile, while various terms including the service hub, the service hub program, and the icon container are used, they indicate the service for integrally managing and supporting the plurality of the services, and may be expressed as other terms of the same meaning.

The service providing method, according to various embodiments of the present invention, can be stored to various recording media and implemented by program codes executed by a CPU of the user terminal device or the server main body.

In more detail, the codes for executing the above service providing methods can be stored to various recording media readable by the terminal, such as, for example, Random Access Memory (RAM), flash memory, Read Only Memory (ROM), Erasable Programmable ROM (EPROM), Electronically Erasable and Programmable ROM (EEPROM), register, hard disc, removable disc, memory card, USB memory, and CD-ROM.

While the invention has been shown and described with reference to certain embodiments thereof, it will be understood by those skilled in the art that various changes in form and detail may be made therein without departing from the spirit and scope of the invention as defined by the appended claims.

1. A service method of a server for providing a hub service, the service method comprising the steps of:
providing access to a user terminal device;
determining whether the user terminal device is a pre-registered device;
transmitting a service hub program set for the user terminal from the server to the user terminal device, when the user terminal device is the pre-registered device; and
transmitting at least one application program corresponding to the service hub program and the user terminal device, from the server to the user terminal device.

2. The service method of claim 1, wherein the service hub program is a program adaptively generated for an organization according to a request of the organization to which a user of the user terminal device is belonged, the service hub program generates an icon container comprising an icon for the application program in the user terminal device, and the at least one application program is a program that is selectively used for the service hub program and the user terminal device.

3. The service method of claim 1, wherein determining whether the user terminal device is the pre-registered device comprises:
receiving unique information and user information of the user terminal device, from the user terminal device;
determining whether the user terminal device is a device registered by an organization that requests the hub service for the server by comparing the unique information and the user information with pre-stored device information; and
transmitting an authentication result to the user terminal device,
wherein the service hub program is transmitted to the user terminal device when a transmission request is received from the user terminal device that has received authentication result.

4. The service method of claim 1, further comprising:
when the user terminal device is the pre-registered device, transmitting a first list of at least one preset application program corresponding to the service hub program and the user terminal device, and a second list of icons of the at least one application program, to the user terminal device.

5. The service method of claim 4, wherein transmitting the at least one application program to the user terminal device comprises:
receiving a download request or an update request for at least one of the at least one preset application program of the first list; and
transmitting application programs or update data to the user terminal device according to the download request or the update request.

6. The service method of claim 4, wherein the first list is a list of at least one application program to provide for a group or a user level of the user among all of application programs provided to an organization of the user of the user terminal device.

7. The service method of claim 6, wherein the first list and the second list are regenerated when at least one of the user terminal device, the organization, the group, and an application program setting status is changed.

8. The service method of claim 1, further comprising:
limiting access of the user terminal device belonging to a user party, when a load occurs in the user party.

9. The service method of claim 1, further comprising:
limiting the hub service, when a load occurs in a particular service.

10. The service method of claim 1, further comprising:
storing backup information of at least one of unique information of the user terminal device, user information of the user terminal device, service hub program information provided for the user terminal device, and application program information for the service hub program; and
providing the backup information as sharing information.

11. The service method of claim 1, wherein transmitting the application program to the user terminal device comprises:
receiving a request for checking whether to download or update the application program, from the user terminal device;
generating a list of application programs to newly download or update according to the request and sending the list to the user terminal device; and
when receiving a download request or an update request for at least one of the application programs of the list, transmitting the requested application program or update data to the user terminal device.

12. The service method of claim 1, further comprising:
periodically checking whether a state of the user terminal device is changed.

13. The service method of claim 12, further comprising:
when the state of the user terminal device is changed, generating a list of application programs to delete among the at least one application program provided to the user terminal device, and transmitting the list to the user terminal device.

14. The service method of claim 1, further comprising:
when the state of the user terminal device is changed, transmitting an instruction to delete at least one of the at least one application program provided to the user terminal device, the service hub program, and data generating in every program execution, to the user terminal device.

15. The service method of claim 1, further comprising:
receiving location information that occurs when the service hub program is initially executed in the user terminal device; and
selecting the service hub program to use in the user terminal device and an application program to be managed in a lump by the service hub program using unique information and the location information of the user terminal device.

16. A server for providing a hub service, comprising:
a contents server unit for storing service hub programs and application programs;
a front server unit for, when a user terminal device is provided access, determining whether the user terminal device is a pre-registered device; and
a main server unit for, when the user terminal device is the pre-registered device, controlling the front server unit to transmit a service hub program corresponding to the user terminal device and at least one application program corresponding to the service hub program and the user terminal device, among the service hub programs and the application programs stored to the contents server unit, to the user terminal device.

17. The server of claim 16, wherein the service hub program is a program adaptively generated for an organization according to a request of the organization to which a user of the user terminal device is belonged, the service hub program generates an icon container comprising an icon for the application program in the user terminal device, and the at least one application program is a program that is selectively used for the service hub program and the user terminal device.

18. The server of claim 16, wherein the front server unit comprises:
an authentication manager for receiving unique information and user information of the user terminal device from the user terminal device, determining whether the user terminal device is a device registered by an organization that requests the hub service for the server by comparing the unique information with pre-stored device information, and transmitting an authentication result to the user terminal device; and
a service handler for, when a transmission request is received from the user terminal device that has received the authentication result, transmitting the service hub program corresponding to the user terminal device, to the user terminal device.

19. The server of claim 16, wherein the front server unit comprises:
an access limiter for, when a load occurs in a user party, limiting access of the user terminal device belonging to the user party.

20. The server of claim 19, wherein the main server unit comprises:
an access limit policy establisher for establishing and executing an access limit policy for controlling operations of the access limiter.

21. The server of claim 16, wherein the front server unit comprises:
a service limiter for, when a load occurs in a service, limiting the service.

22. The server of claim 21, wherein the main server unit comprises:
a service limit policy establisher for establishing and executing a service limit policy for controlling operations of the service limiter.

23. The server of claim 16, further comprising:
an open server unit for storing backup information of at least one of unique information of the user terminal device, user information of the user terminal device, service hub program information provided for the user terminal device, and application program information for the service hub program, and providing the backup information as sharing information.

24. The server of claim 16, wherein, when receiving a request for checking whether to download or update the application program from the user terminal device, the service handler generates and transmits a list of application programs to newly download or update, to the user terminal device, and when receiving a download request or an update request for at least one of the application programs of the list, the service handler transmits the requested application program or update data to the user terminal device.

25. The server of claim 16, wherein, when a location of the user terminal device leaves an effective area, the main server unit disables the service hub program or at least one application program for the service hub program with respect to the user terminal device.

26. The server of claim 16, wherein the main server unit periodically checks whether a state of the user terminal device is changed.

27. The server of claim 26, wherein, when the state of the user terminal device is changed, the front server unit generates a list of application programs to delete among the at least one application program provided to the user terminal device, and transmits the list to the user terminal device.

28. The server of claim 16, wherein, when the state of the user terminal device is changed, the front server unit transmits an instruction to delete at least one of the at least one application program provided to the user terminal device, the service hub program, and data generating in every program execution, to the user terminal device.

29. The server of claim 16, wherein the front server unit receives location information that occurs when the service hub program is initially executed in the user terminal device, and selects the service hub program to use in the user terminal device and an application program to be managed in a lump by the service hub program using unique information and the location information of the user terminal device.

30. The server of claim 16, wherein the main server unit provides the front server unit with information relating to the service hub program to provide to the organization of the user of the user terminal device and information relating to the at least one application program to provide to the user, and the front server unit transmits the service hub program and the at least one application program to the user terminal device according to the provided information.
